(19) United States
(12) Patent Application Publication
(10) Pub. No.: US 2007/0286095 A1
(43) Pub. Date: Dec. 13, 2007

(54) Redundant session information for a distribution network

(75) Inventor: Robert C. Ottinger, Boulder, CO (US)

Correspondence Address: COATS & BENNETT/ERICSSON WIRELESS COMM''S., INC., 1400 CRESCENT GREEN, SUITE 300, CARY, NC, 27518, US

(73) Assignee: Telefonaktiebolaget LM Ericsson (publ)

(21) Appl. No.: 11/449,302

(22) Filed: Jun. 8, 2006

(51) Int. Cl. H04L 12/28; H04Q 7/24

(52) U.S. Cl. 370/254; 370/338

(57) ABSTRACT

A mobile communication network comprises a plurality of access nodes, each of which includes a transceiver system for communicating with mobile stations and a control circuit for controlling operation of said access node. A group of access nodes defines a subnet. Each access node in a subnet stores state information for the other access nodes in the subnet in a subnet information table (SIT) and sends a periodic broadcast message to the other access nodes at a periodic interval. The periodic broadcast message may indicate a change in the state or configuration of an access node. Access nodes may also send an information request to another access node in response to a periodic broadcast message when the periodic broadcast message indicates that the sending access node has changed state or configuration.

### BACKGROUND

The present invention relates generally to mobile communication networks and more particularly, to mobile communication networks having a distributed architecture.

Most radio access networks (RANs) employed today use a hierarchical network architecture in which each higher level entity supports multiple lower level entities. HRPD networks according to the Third Generation Partnership Project 2 (3GPP2) standard exemplify this type of hierarchical network. In HRPD networks, a packet control function performing session control and mobility management functions connects multiple base station controllers (also known as access network controllers) to the core network. Each base station controller, in turn, connects to multiple radio base stations and performs radio resource control functions. The radio base stations communicate over the air interface with the mobile stations. This conventional hierarchical architecture has worked well for voice services and most packet data services.

Recently, there has been some interest in developing a distributed RAN architecture in which the radio base station, base station controller, and packet control function are integrated into a single network entity with a connection to the PDSN. These all-in-one nodes help reduce the amount of hardware in the network by taking advantage of spare processing capacity in the radio base station. In the new distributed architecture, functions traditionally performed by centralized nodes, such as session management and mobility management, are distributed among a plurality of network nodes. Thus, a distributed architecture requires coordination between nodes to perform functions such as session management and mobility management.

### SUMMARY

A mobile communication network comprises a plurality of access nodes, each of which includes a transceiver system for communicating with mobile stations and a control circuit for controlling operation of the access node. A group of access nodes defines a subnet. Each access node in a subnet stores state information for the other access nodes in the subnet in a subnet information table (SIT) and sends a periodic broadcast message to the other access nodes in the subnet at a periodic interval. The periodic broadcast message may indicate a change in the state or configuration of an access node. Access nodes may also send an information request to another access node in response to a periodic broadcast message when the periodic broadcast message indicates that the sending access node has changed state or configuration.

### BRIEF DESCRIPTION OF THE DRAWINGS

FIG. 1 illustrates an exemplary mobile communication network with a distributed architecture.

FIG. 2 illustrates grouping of access nodes to form subnets.

FIG. 3 illustrates logical elements in an exemplary access node for a mobile communication network.

FIG. 4 illustrates the format of an exemplary Universal Access Terminal Identifier.

FIG. 5 illustrates the format of an exemplary Periodic Broadcast Message.

FIG. 6 illustrates an exemplary procedure for sending periodic broadcast messages.

FIG. 7 illustrates an exemplary procedure for processing Periodic Broadcast Messages.

FIG. 8 illustrates the format of an exemplary Information Request Message.

FIG. 9 illustrates the format of an exemplary Information Response Message.

### DETAILED DESCRIPTION

The present invention relates to a peer-to-peer signaling protocol for signaling between access nodes in a mobile communication network where the session control function is distributed among the access nodes instead of being located at a central location. According to one exemplary embodiment of the present invention, the access nodes are grouped into subnets. Each access node in a subnet maintains a subnet information table (SIT) to store information about the other access nodes in the same subnet. To keep the SIT current, each access node sends a periodic broadcast message to the other access nodes in the subnet. Access nodes may also send an information request message to another access node when a change in configuration is indicated by the periodic broadcast message. To aid in understanding the invention, a exemplary network 10 with a distributed architecture is first described to provide a context for the invention. The signaling protocol will then be described.

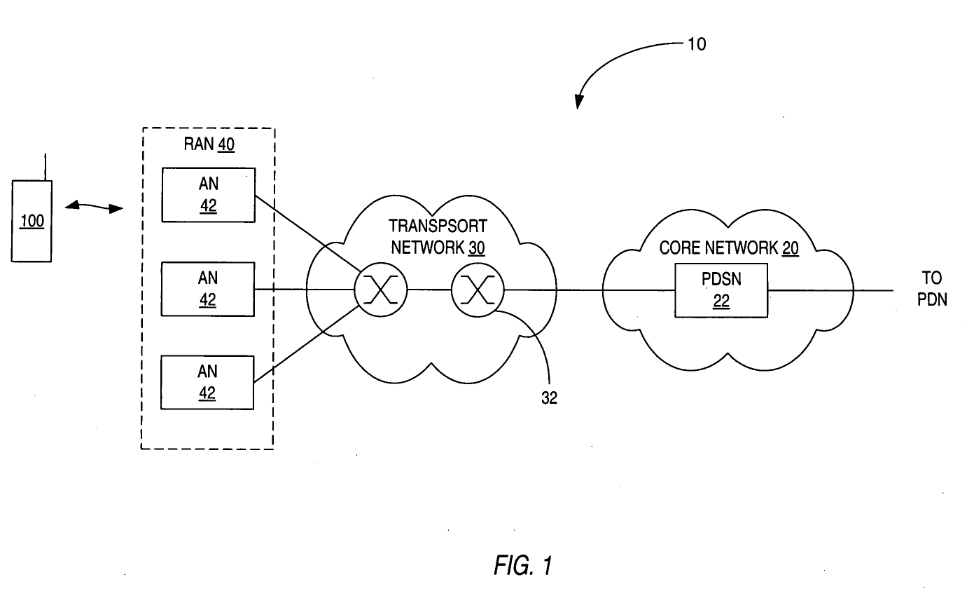

FIG. 1 illustrates an exemplary mobile communication network 10 according to one embodiment of the invention for providing wireless communication services to mobile stations 100. Mobile communication network 10 comprises a packet-switched core network 20 including a Packet Data Serving Node (PDSN) 22, an IP-based transport network 30, and a radio access network 40 comprising one or more access nodes (ANs) 42. The PDSN 22 connects to an external packet data network (PDN), such as the Internet, and supports PPP connections to and from the mobile stations 100. IP streams are added and removed between the ANs 42 and the PDSN 22. PDSN 22 routes packets between the external packet data network and the ANs 42. The transport network 30 comprises one or more routers 32 and connects ANs 42 with the core network 20. ANs 42 integrate the functions of a radio base station, access network controller, and packet control function into a single network element. The ANs 42 may operate, for example, according to the Telecommunications Industry Association (TIA) standard TIA-856-A (3GPP2 C.S0024-A), which defines an air interface between the AN 42 and mobile stations 100. Those skilled in the art will appreciate that the present invention may also use in other air interface standards, such as TIA-2000 and the emerging Wideband CDMA standard.

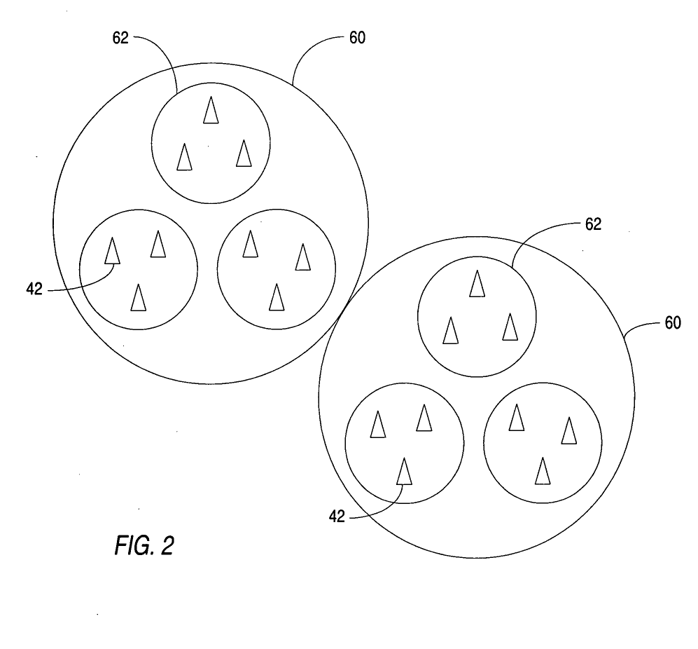

ANs 42 are grouped to form subnets 60 as shown in FIG. 2. Each subnet 60 preferably covers a large area referred to herein as a multicast area. Each subnet 60 is further divided into smaller areas referred to herein as color code areas 62, which may encompass one or more ANs 42.

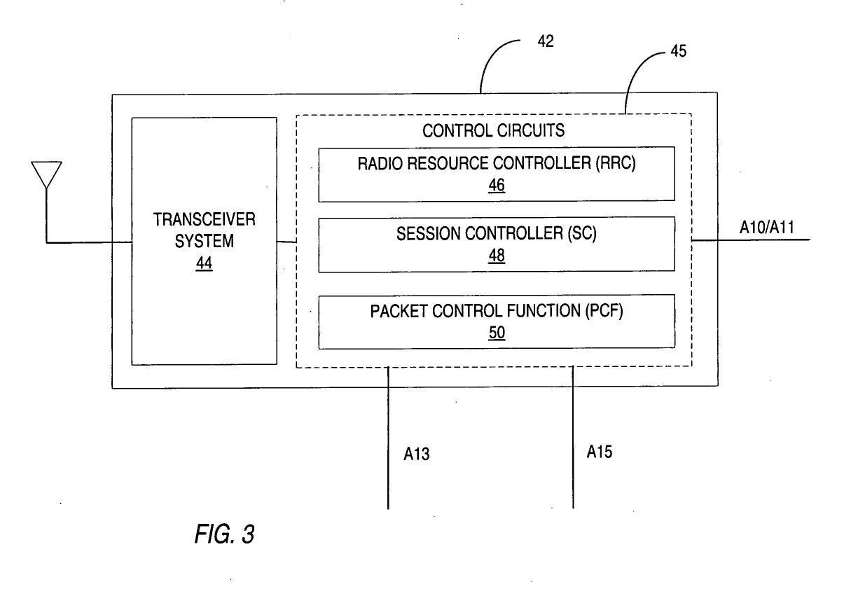

FIG. 3 illustrates the logical elements of an AN 42 in one exemplary embodiment. The exemplary AN 42 comprises a transceiver system 44 and associated control circuits 45, including a radio resource controller (RRC) 46, a session controller (SC) 48, and a Packet Control Function (PCF) 50 as defined in TIA-1878-1 (3GPP2 A.S0008 v3.0). The transceiver system 44 includes the radio equipment for communicating over the air interface with the mobile stations 100. The radio resource controller 46 manages radio and communication resources for the AN 42. The session controller 48 performs session control and mobility management (SC/MM) functions. The PCF 50 establishes, maintains, and terminates connections from AN 42 to PDSN 22. Thus, the access network controller and packet control functions are distributed among all of the access nodes 42 rather than residing in a central node or location.

Between the AN 42 and the PDSN 22, the user data travels over the A10 communication link. Generic Routing Encapsulation (GRE) is used to transport data over the A10 connections. GRE is a well-known protocol for encapsulation of an arbitrary network layer protocol over another arbitrary network layer protocol. The GRE protocol is described in the Internet Engineering Task Force (IETF) standard identified as RFC 2784. Signaling data travels between AN 42 and PDSN 22 over the A11 link. Signaling between the ANs 42 travels over the A13 and A15 communication links. The A13 communication link is used to transfer session information between ANs 42. The Al 5 communication link is used for inter-AN paging. The AN 42 communicates with an AAA (Authentication, Authorization, and Accounting) server over the A12 communication link to authenticate mobile stations 100 attempting to access the network 10. The A10, A11, A12, A13 and A15 interfaces are defined in TIA-1878 (3GPP2 A.S0007-A).

To transmit or receive packet data, the mobile station 100 establishes a packet data session with the PDSN 22. For each packet data session, AN 42 opens one or more radio packet (R-P) connections (also called an Al 0 connection) with the PDSN 22 to establish a transmission path for user data between PDSN 22 and AN 42 for packet data. The mobile station 100 negotiates session parameters with the AN 42 and establishes a traffic channel (TCH) with the AN 42 for forward and reverse traffic. The session parameters include the protocols used for communication between AN 42 and mobile station 100, and the protocol settings. The session parameters are stored by the session controller 48 at the AN 42.

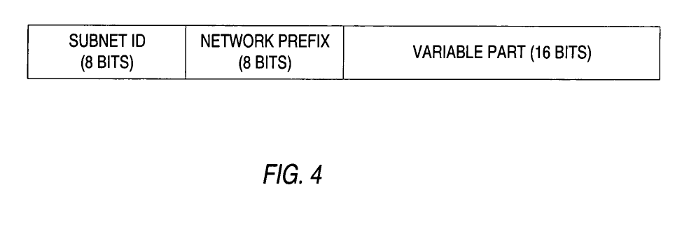

When the packet data session is established, the mobile station 100 is assigned a Universal Access Terminal Identifier (UATI) to use for the duration of the session. The UATI uniquely identifies the mobile station 100 to the ANs 42 within a subnet 60. In one exemplary embodiment, the UATIs are divided among the ANs 42 in the subnet 60 and have the structure shown in FIG. 4. Thus, each AN 42 has its own pool of UATIs to allocate to mobile stations 100. In the embodiment shown in FIG. 4, the UATI comprises 32 bits. The 16 least significant bits of the UATI are variable and are selected by AN 42 when an HRPD session is set up. These 16 bits uniquely identify the mobile station 100 to the AN 42. The 8 middle bits are fixed for a given AN 42 and uniquely identify an AN 42 within a given color code area 62. These 8 bits indicate which AN 42 in a color code area 62 is storing the session information. The 8 most significant bits are fixed and uniquely identify a color code area 62 in a subnet 60. If the subnet 60 has a single color code area 62, the 8 bits used to identify the color code area 62 would not be needed. In that case, the length of the variable part could increased to 24 bits rather than 16 bits, or the overall length of the UATI could be reduced to 24 bits In the case where the variable part is 16 bits in length, each AN 42 has approximately 65,000 UATIs to allocate to mobile stations 100. Those skilled in the art will appreciate that additional bits could be used to identify the subnet 60 to provide unique UATIs across the entire network 10.

During the packet data session, the mobile station 100 receives data from only one AN 42 at a time, which is referred to herein as the serving AN. When the mobile station 100 moves between cells, a handover is performed. A handover is a procedure for transferring a session or call from one AN 42 to another. The AN 42 releasing the mobile station 100 during a handover is called the source AN and the AN 42 acquiring the mobile station 100 during the handover is called the target AN. When the handover is complete, the target AN becomes the new serving AN.

In the exemplary embodiments described herein, an AN 42 can serve five different roles in support of a packet data session. For convenience, the ANs 42 are denominated herein as a connecting AN, anchor AN, primary AN, secondary AN, or serving AN depending on the role that the AN 42 serves for a given mobile station 100. In some instances, an AN 42 can simultaneously serve multiple roles. The connecting AN is the AN 42 to which the mobile station 100 sends access requests when it wants to establish a connection for transmitting or receiving data. The anchor AN for a given mobile station 100 is the AN 42 where the Al 0 connection for the mobile station 100 terminates. In general, the anchor AN will function as the serving AN for forward link packet communications, though this is not required. The primary AN for a given mobile station 100 is the AN 42 that stores the location and session information for the mobile station 100. The primary AN, according to one exemplary embodiment, allocates a UATI to the mobile station and performs session control functions as defined in TIA-1878 for the communication session (i.e. HRPD session). The serving AN is the AN 42 that transmits data to the mobile station 100 over the forward Traffic Channel (FTC). The serving AN may be an anchor AN, primary AN, or secondary AN. If the serving AN is not the anchor AN, the serving AN connects with the anchor AN over a side haul connection to provide a transmission path for user data between the serving AN and the anchor AN.

Each AN 42 in a subnet 60 is configured with a pool of UATIs that it may allocate to mobile stations 100. In general, the primary AN and anchor AN will be different. The secondary AN for a given mobile station 100 stores the address of the anchor AN, which stores a redundant copy of the session information, in case the primary AN becomes unavailable. Each AN 42 in a subnet 60 is capable of determining the address of and accessing the primary AN for a given mobile station 100 that has been assigned a UATI by another AN 42 within the subnet 60. In the exemplary embodiment, the identity of the primary AN is determined based on the UATI, which is typically included in access channel messages sent by the mobile station 100 over the reverse access channel. Based on the UATI obtained from the mobile station 100, any AN 42 can determine the identity of the primary AN. For example, an AN 42 can store a mapping table that maps UATI values to the corresponding AN address. Once a mobile station 100 has been assigned a UATI, the mobile station 100 keeps the same UATI for the lifetime of an HRPD session, unless it moves into a different subnet 60. Methods of allocating UATIs to the mobile stations 100 are described in a U.S. patent application Ser. No. 11/324,186 entitled “METHOD OF ALLOCATING MOBILE STATION IDENTIFERS AND USING MOBILE STATION IDENTIFIERS TO LOCATE SESSION INFORMATION,” filed Dec. 30, 2005. This application is incorporated herein by reference.

The primary AN serves as the principal location for storing session information for an HRPD session with a mobile station 100 and performs the session control function. The primary AN is capable of determining the address of and accessing the anchor AN. Both the primary AN and anchor AN store the current location of the mobile station 100 (i.e., the address of the AN 42 that last received an access message from or last served the mobile station 100). Also, both the anchor AN and primary AN store the session state information records (SSIRs) for the mobile station 100. The session information stored in the primary AN is the same as the session information stored in the anchor AN, except during transient periods of time when the session is being updated or modified. As will be described in more detail below, it is possible to deliver data to the mobile station 100 as long as either the primary AN or anchor AN is available.

In the exemplary embodiment, each AN 42 is also capable of determining the address of and accessing the secondary AN of a given mobile station 100 if the primary AN becomes unavailable. When the primary AN is unavailable, the secondary AN provides the address of the anchor AN upon request from any other AN 42 in subnet 60. The primary and secondary ANs are always distinct. For simplicity, mobile stations 100 assigned to the same primary AN may also be assigned to the same secondary AN. It is not required, however, that mobile stations 100 assigned to the same primary AN shall also have the same secondary AN. In some embodiments, the secondary AN could also store the mobile station location and session information and thus serve as a backup to the primary AN. In this case, the secondary AN could provide session information to another AN 42 upon request. Storing the mobile station location and session information in the secondary AN provides a greater degree of robustness and allows the network 10 to deliver data to a mobile station 100 as long as either the primary AN, secondary AN, or anchor AN is available. 26 In the distributed network 10 described above, the mobile station 100 keeps its assigned UATI for the lifetime of an HRPD session unless it moves out of the subnet 60. The problem of UATI pool exhaustion in an AN 42 close to an airport is mitigated, since the UATI assignment is distributed to all ANs 42 in the subnet. The task of moving Al 0 connections when an anchor RBS becomes unavailable is distributed to many ANs 42 in the subnet 60. There is no need to move A10 connections when an AN 42 becomes available. It is also possible to add and remove an AN 42 from a subnet 60 with no bulk moving of sessions from one AN 42 to another. Many of the exemplary procedures also provide “self-healing” properties to the network 10.

To enable interoperations between ANs 42 as described above, each AN 42 maintains a subnet information table (SIT) that contains information about the other ANs 42 in the subnet 60. The SIT is used to perform many functions. For example, the SIT may be used to select a primary AN when a session is established, to determine the identity of the primary AN for a given mobile station 100, to determine the IP address of the primary AN to request session information, to determine the identity of a secondary AN when a primary AN fails, to perform a route update procedure, and to page a mobile station 100. The SIT may be used in other circumstances as well.

The SIT stores basic state information for each AN 42 in the same subnet 60. Such basic state information for an access node may include, for example, an access node identification number (ANID), the IP address of the AN 42, the IP address of a corresponding secondary node, and the geographic location of the AN 42. The SIT may also store a state sequence number for each AN 42. The state sequence number is incremented each time the state or configuration of an AN 42 is updated.

Each AN 42 may further include a configuration database (CDB) that stores more detailed information about its neighbors. An AN 42 will typically need more detailed information about nearby ANs 42, which is not needed for more remote ANs 42. The CDB stores the detailed state information for neighboring ANs 42.

A signaling protocol, referred to herein as the Subnet Information Exchange Protocol (SIEP), provides a mechanism to keep the SIT and CDB updated. Each AN 42 in the subnet 60 is programmed to periodically send a Periodic Broadcast Message (PBM) to other access nodes in the same subnet 60. Additionally, each access node may send an information request to any other access node to obtain information beyond what is contained in the PBM.

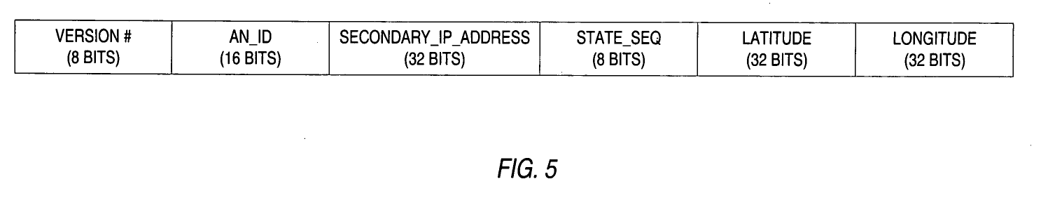

FIG. 5 illustrates a format for an exemplary PBM. The information elements (IEs) in the PDM include the VERSION, the AN_ID, the SECONDARY_IP_ADDRESS, the STATE_SEQ, the LATITUDE, and the LONGITUDE for the AN 42. The VERSION information element contains the version number for the SEIP protocol. The AN_ID contains a 16-bit identification of the AN 42 that uniquely identifies the AN 42 in the subnet 60. The SECONDARY_IP_ADDRESS information element contains the IP address of the AN 42 that serves as the secondary AN, if any. If there is no designated secondary AN, this field may be left empty or may be deleted. The STATE_SEQ information element indicates the current configuration state of the AN 42 and is incremented each time the configuration state changes. The LATITUDE and LONGITUDE information elements indicate the location of AN 42. This information is useful, for example, to identify neighboring access nodes, for paging mobile stations 100, and for distance based route updating. In one embodiment of the invention, the control circuit 45 uses the location information, e.g. latitude and longitude, to dynamically select other ANs 42 for inclusion in a neighbor list. In another embodiment of the invention, the AN 42 uses the location information for distance based route-updating.

The frequency of the PBM is determined based on a periodic broadcast interval (PBI). In one exemplary embodiment, the PBI is set to a default value of 60 seconds, but may be changed by the service provider as needed. Each AN 42 sends a PBM to all other ANs.42 in the same subnet once during each PBI. The PBI may be divided into 20 msec timeslots. Each AN 42 selects a random timeslot during each PB! to broadcast its PBM to the other ANs 42 in the subnet. Additionally, an AN 42 may be configured to broadcast its PBM immediately when a state change occurs.

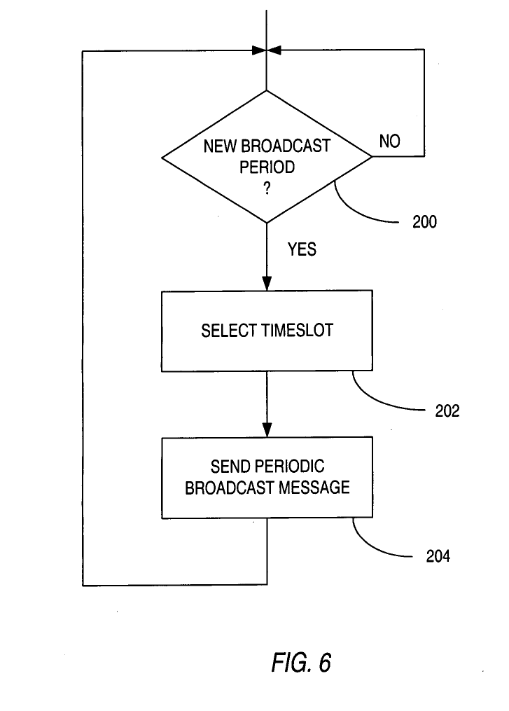

FIG. 6 illustrates an exemplary procedure implemented by an AN 42 for broadcasting PBMs. When AN 42 detects the beginning of a new PBI (block 200), it selects a 20 msec timeslot in which to send a PBM to the other ANs 42 (block 202). The AN 42 transmits the PBM during the selected timeslot (block 204). This procedure repeats as long as the AN 42 is available.

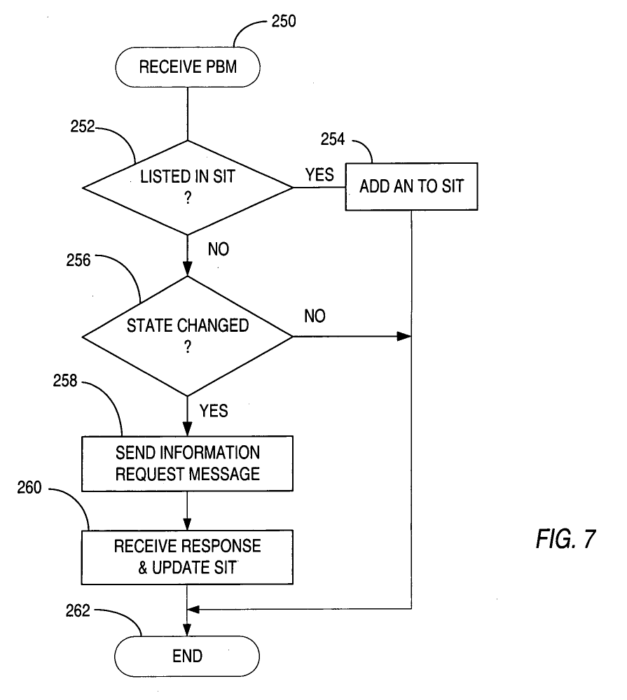

Each AN 42 receives PBMs from the other ANs 42. FIG. 7 illustrates an exemplary procedure for processing Periodic Broadcast Messages. The procedure begins when an AN 42, referred to herein as the receiving node, receives a Periodic Broadcast Message from another AN 42, referred to herein as the originating node (block 250). After receiving the Periodic Broadcast Message, the receiving AN checks whether the originating AN is listed in the SIT (block 252). If not, the receiving AN adds the originating AN to the SIT (block 254). The receiving AN then checks whether the originating AN has changed state (block 254). If so, the receiving AN may send an Information Request Message to the originating AN and waits for a response (block 258). When the response is received, the receiving AN updates its CDB and/or SIT (block 260) and the procedure ends (block 262). The AN 42 may use the location information received in the PBM in determining whether to send an Information Request to the originating AN 42.

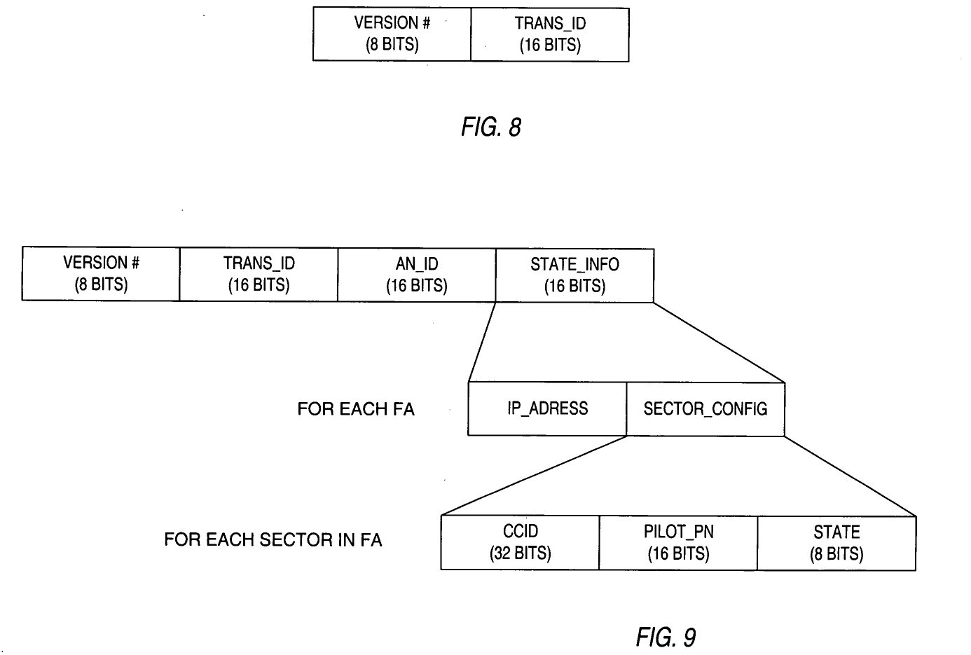

FIGS. 8 and 9 illustrate exemplary information request and information response messages, respectively. The information request message in FIG. 8 contains the following fields: VERSION# and TRANS_ID. The VERSION# indicates the version of the SEIP protocol being used. The TRANS_ID identifies the transaction initiated by the information request. The information response message in FIG. 9 includes the following fields: VERSION#, TRANS_ID, AN_ID, and STATE_INFO. The VERSION# and TRANS_ID contain the same information described in connection with the information request message. The AN_ID identifies the AN 42 responding to the information request. The STATE_INFO includes a corresponding IP address (IP_ADDRESS) for each frequency assignment (FA). Also, the STATE_INFO includes, for each sector in an FA, the CDMA channel ID (CCID), pilot pseudo-noise sequence (PILOT_PN), and current state (STATE). Additional information may also be included.

The SIT and SIEP enable the service provider to more easily make configuration changes without having to push configuration data to all ANs 42. The SIEP enables the ANs 42 to automatically detect changes and updates the SIT to reflect such changes. The SIEP also enables the ANs 42 to detect certain errors conditions, such as when an AN 42 fails. The PBM functions as a “heartbeat” that can be monitored by the other ANs 42. When the “heartbeat” ceases, the other ANs 42 are alerted that the AN 42 is no longer available. Trigger zone and distance-based paging may be accomplished easier when all ANs 42 have knowledge of the other ANs 42 and their location.

The present invention may, of course, be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A signaling method for signaling between access nodes in a subnet, said signaling method comprising:
storing a subnet information table in a first access node in said subnet, said subnet information table including state information for other access nodes in said subnet; and
sending a periodic broadcast message periodically from said first access node to said other access nodes in said subnet, said periodic broadcast message including an identifier that identifies said first access node and state information for said first access node.

2. The signaling method of claim 1 wherein said state information comprises a second identifier that identifies a secondary access node associated with the first access node.

3. The signaling method of claim 2 wherein the second identifier comprises an address of said secondary access node.

4. The signaling method of claim 1 wherein said state information comprises a state sequence number that changes whenever the configuration of the first access node changes.

5. The signaling method of claim 1 wherein the state information stored in said memory includes location information for said access nodes.

6. The signaling method of claim 5 further including selecting one or more access nodes in said subnet for inclusion in a neighbor list based on said location information.

7. The signaling method of claim 1 further comprising receiving at said first access node an information request from a second access node in said subnet responsive to said periodic broadcast message, and sending to said second access node an information response including additional state information.

8. A signaling method for signaling between access nodes in a subnet, said signaling method comprising:
storing a subnet information table in a first access node in said subnet, said subnet information table including state information for other access nodes in said subnet;
receiving a periodic broadcast messages at said first access node periodically from said other access nodes in said subnet, said periodic broadcast messages including first identifiers that identify the other access nodes sending the periodic broadcast messages and state information for said other access nodes; and
updating said subnet information table based on said periodic broadcast messages.

9. The signaling method of claim 8 wherein updating said subnet information table based on said periodic broadcast messages comprises adding an access node to said subnet information table when a new access node is detected.

10. The signaling method of claim 9 wherein updating said subnet information table based on said periodic broadcast messages comprises modifying an entry in said subnet information table when said first access node fails to receive a periodic broadcast message from another access node in said subnet information table.

11. The signaling method of claim 8 wherein said state information comprises second identifiers that identify secondary access nodes associated with the first access nodes.

12. The signaling method of claim 11 wherein the second identifiers comprise addresses of said secondary access nodes.

13. The signaling method of claim 8 wherein said state information further comprises state sequence numbers that change whenever the configuration of the access nodes change.

14. The signaling method of claim 13 further comprising sending an information request to a second access node in said subnet responsive to said periodic broadcast message when said state sequence number changes.

15. The signaling method of claim 14 further comprising:
receiving an information response from said second access node including additional state information responsive to said information request; and
updating said subnet information table.

16. The signaling method of claim 8 wherein the state information stored in said memory includes location information for said access nodes.

17. The signaling method of claim 16 further comprising sending an information request to a second access node in said subnet responsive to said periodic broadcast message when the said location information meets a certain criteria.

18. The signaling method of claim 16 further including selecting one or more access nodes in said subnet for inclusion in a neighbor list based on said location information.

19. An access node in a subnet of a mobile communication network, said access node comprising:
memory for storing a subnet information table, said subnet information table including state information for other access nodes in said subnet; and
a control circuit configured to send a periodic broadcast message periodically from said access node to said other access nodes in said subnet, said periodic broadcast message including an identifier that identifies said access node and state information for said access node.

20. The access node of claim 19 wherein said state information comprises a second identifier that identifies an associated secondary access node.

21. The access node of claim 20 wherein the second identifier comprises an address of said secondary access node.

22. The access node of claim 19 wherein said state information comprises a state sequence number that changes whenever the configuration of the access node changes.

23. The access node of claim 19 wherein the state information stored in said memory includes location information for said access node.

24. The access node of claim 23 wherein the control circuit is further configured to select one or more other access nodes in said subnet for inclusion in a neighbor list based on said location information.

25. The access node of claim 19 wherein said control circuit is further configured to:
receive an information request from a second access node in said subnet responsive to said periodic broadcast message; and
send to said second access node an information response including additional state information.

26. An access node in a subnet of a mobile communication network, said access node comprising:
memory storing a subnet information table, said subnet information table including state information for other access nodes in said subnet; and
a control circuit configured to:
receive periodic broadcast messages periodically from said other access nodes in said subnet, said periodic broadcast messages including first identifiers that identify said other access nodes sending the periodic broadcast messages and state information for said other access nodes; and
update said subnet information table based on said periodic broadcast messages.

27. The access node of claim 26 wherein said control circuit updates said subnet information table based on said periodic broadcast messages by adding a new access node to said subnet information table when the new access node is detected.

28. The access node of claim 27 wherein said control circuit updates said subnet information table based on said periodic broadcast messages by modifying an entry in said subnet information table when said access node fails to receive a periodic broadcast message from another access node in said subnet information table.

29. The access node of claim 26 wherein said state information further comprises second identifiers that identify secondary access nodes associated with the access node.

30. The access node of claim 29 wherein the second identifiers comprise addresses of said secondary access nodes.

31. The access node of claim 26 wherein said state information further comprises state sequence numbers that change whenever the configuration of the access nodes change.

32. The access node of claim 31 wherein the control circuit is further configured to send an information request to a second access node in said subnet responsive to said periodic broadcast message when said state sequence number changes.

33. The access node of claim 32 wherein the control circuit is further configured to receive an information response from said second access node including additional state information responsive to said information request, and to update said subnet information table.

34. The access node of claim 26 wherein the state information further comprises location information for said access node.

35. The access node of claim 34 wherein the control circuit is further configured to send an information request to a second access node in said subnet responsive to said periodic broadcast message when determining that the location information meets a certain criteria.

36. The access node of claim 34 wherein the control circuit is further configured to select one or more other access nodes in said subnet for inclusion in a neighbor list based on said location information.
